(19) United States
(12) Patent Application Publication
(10) Pub. No.: US 2017/0240394 A1
(43) Pub. Date: Aug. 24, 2017

(54) WIRELINE SHEAVE DEVICE AND METHOD OF USE

(71) Applicants: Shane Eastman, Lancaster, MA (US); Paul George, Denver, CO (US)

(72) Inventors: Shane Eastman, Lancaster, MA (US); Paul George, Denver, CO (US)

(21) Appl. No.: 15/437,251

(22) Filed: Feb. 20, 2017

Related U.S. Application Data
(60) Provisional application No. 62/297,475, filed on Feb. 19, 2016.

(51) Int. Cl. B66D 3/26; F16N 31/00; F16N 19/00

(52) U.S. Cl. CPC B66D 3/26; F16N 19/00; F16N 31/00; E21B 19/008

(57) ABSTRACT

Devices for use with wireline sheaves are provided that allow for capturing grease freed from a wireline as it passes around an upper sheave during wireline retraction from a wellbore. Once the freed grease is captured, it is reapplied to the wireline as it passes from the upper sheave to the lower sheave where the grease may be captured for disposal.

### CROSS REFERENCE

This application claims the benefit of the filing date of U.S. Provisional Application No. 62/297,475 having a filing date of Feb. 19, 2016, the entire contents of which are incorporated herein by reference.

### FIELD

The present disclosure relates generally to wireline sheaves for use in conducting downhole well operations including well completion activities, well servicing activities and the installation and removal of downhole well equipment where wireline services are utilized. More particularly, the present disclosure is directed to a wireline sheave and/or sheave housing that significantly reduces the grease/oil (e.g., fluid) that is expelled into the environment during use of a wireline sheave.

### BACKGROUND

Various downhole activities require insertion of tools or implements into a well during well drilling, intervention, construction, repair, and after the well is drilled. For instance, during well operations, it is sometimes necessary to conduct well bore logging activities where a logging tool is run into the well to evaluate the progress of the well bore and/or to identify various characteristics of the formation being traversed by the well bore. Likewise, it is sometimes necessary to insert tools into the well after concluding drilling to, for example, complete the well. One non-limiting example is well casing perforation. Such operations are typically carried out by running various tools into the well by means of wireline cables. During some of these operations, such tools are inserted while the wellbore experiences high pressure conditions (e.g., 5000-10000 psi).

In order to guide the wireline into the well bore, two sheaves are often utilized. A sheave is a pulley with a grooved wheel for holding the wireline. The grooved wheel spins inside a frame of the sheave, which allows the wireline cable to move freely minimizing wear and abrasion on cable. Typically a lower sheave is positioned near the operating surface (e.g., ground level, operating deck etc.) and an upper sheave is position at a height above the wellbore. A wireline cable from a winch unit (e.g., winch truck) is directed upward from near ground level to the upper sheave which redirects the wireline cable back down into the well bore. Often, the upper sheave is suspended a considerable distance above the ground (e.g., 80-100 ft) by a crane or other support device. Accordingly, the wireline cable can feed tools into the wellbore and retract such tools from the wellbore.

During high pressure operations, the wireline typically passes through a pressure regulator that prevents wellbore pressure from blowing out to atmospheric pressure. One such pressure regulator is a grease head attached to the well head and/or a lubricator device on the well head. The wireline passes through a passage in the grease head that provides a tight tolerance fit with the wireline. To maintain a seal with the wireline, the grease head injects grease into the passageway, which maintains the pressure seal between the high pressure wellbore and atmospheric pressure.

As the wireline cable emerges from a well bore (e.g., such as when a well tool is being raised to the surface) the wireline cable is typically coated with well fluid and or grease from the grease head. That is, grease and/or well fluid (hereafter grease) is entrained on or within the cable. Even though the wireline may pass through a grease wiper, a certain amount of the grease will be present on or within the wireline as it passes over the upper wireline sheave. The contact pressure applied by the upper sheave along with centrifugal force present as the wireline passes around the upper sheave results in some of the entrained grease separating from the wireline (e.g., similar to spray off of a bicycle wheel) and being released into the air above the operations. In any case, some of the grease is freed from the cable and, if unconstrained, falls to the surface. This is both environmentally unfriendly and unpleasant for workers below.

In summary, it is sometimes necessary to conduct well intervention activities or similar activities where tools are deployed and run into the well using wireline. During these operations various fluids may be carried on the cable into the surface environment where containment, control and collection are an issue.

### SUMMARY

Aspects of the presented inventions are based, in part, on the realization that prior efforts to alleviate grease freed from a wireline at an upper sheave are unsatisfactory. Specifically, some prior attempts have been directed to use of an entrainment housing that captures the grease and directs the grease into a hose that extends from the upper sheave to the ground surface. However, the present inventors have recognized that, in instances where the top sheave is suspended a considerable distance above the ground, the length and weight of such a recapture hose is both an operational, and safety hazard. Accordingly, the present inventors have recognized that it would be desirable to capture grease freed at the upper sheave and transport this grease to near ground-level without utilizing piping or hoses. More specifically, the inventors have recognized that it would be desirable to utilize the wireline itself to transport grease freed from the upper sheave to near ground-level for recovery.

According to one aspect of the presented inventions, a sheave system and method (i.e., utility) is provided that allows for recapturing grease freed from a wireline at an upper sheave and transporting the freed grease to a lower sheave utilizing the wireline, which extends between the sheaves. In various arrangements, a sheave housing is provided that surrounds at least a portion of a radial edge of a pulley of an upper sheave and contains grease that splays outward from a wireline as it passes around the upper sheave pulley. That is, the grease is contained by the housing. The sheave and sheave housing may be an integral original equipment manufacturing (OEM) device in some arrangements. In other arrangements, the sheave housing may be a separate component that is designed to fit with existing sheaves. In any arrangement, the sheave housing for the upper sheave includes a well or grease trap that collects grease freed from the upper sheave at a location proximate to the entry/exit point of the wireline extending between the upper sheave and the lower sheave. The well/trap typically forms the lowermost portion of the sheave housing (i.e., when the upper sheave is suspended) to collect the accumulated grease. In such an arrangement, when the wireline is passing from the upper sheave toward the lower sheave (e.g., when the wireline is being retracted from the wellbore) the wireline passes through accumulated grease within the well/trap and the accumulated grease is re-entrained onto and/or into the wireline such that it is transported to the lower sheave.

In a further arrangement, the lower sheave may also include a lower sheave housing that maintains grease freed by operation of the lower sheave within its interior. Again, such a lower sheave housing may include a trap or well on lower portion thereof where freed grease is accumulated. The lower trap or well may further include a port that allows the trap/well to discharge into a short hose and/or collection bucket.

### BRIEF DESCRIPTION OF THE DRAWINGS

FIG. 1 illustrates an upper wireline sheave and a lower wireline sheave being used to service a wellhead.

FIG. 2 illustrates a perspective view of a sheave housing.

FIG. 3 illustrates use of the sheaves of FIG. 1 to capture grease at the upper sheave and transport that grease to the lower sheave for recovery.

FIG. 4A illustrates a side view of one embodiment of the upper sheave housing.

FIG. 4B illustrates one embodiment of a bottom surface of the sheave housing of FIG. 4A

FIG. 4C illustrates an alternate embodiment of a bottom surface of the sheave housing of FIG. 4A

FIG. 4D illustrates one embodiment of grease spreading devices used with a sheave housing.

FIG. 5A illustrates another embodiment of a sheave housing.

FIG. 5B illustrates the sheave housing of FIG. 5A in use.

FIG. 6A illustrates a side view of one embodiment of the lower sheave housing.

FIG. 6B illustrates a top view of the lower sheave housing of FIG. 6A

FIG. 6C illustrates an edge view of the lower sheave housing of FIG. 6A.

### DETAILED DESCRIPTION

Reference will now be made to the accompanying drawings, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

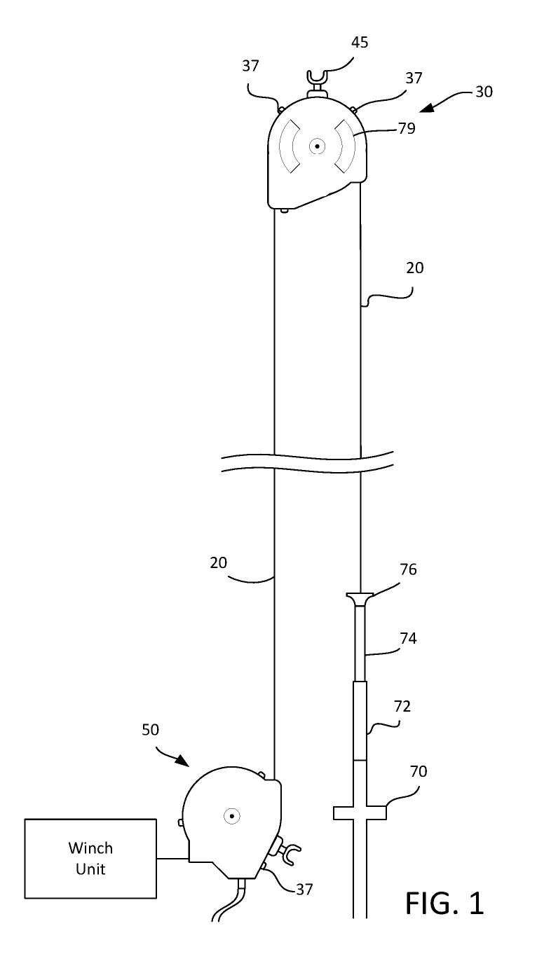

The present disclosure is broadly directed to use of wireline sheaves 30, 50 to direct a wireline 20 into and out of a well head 70. See FIG. 1. Devices disclosed herein allow capturing well fluids and grease (hereafter ‘grease’) entrained on or within the retracted wireline 20 at the upper sheave 30 rather than allowing the grease to spray off as the wireline passes around the upper sheave. The captured grease is then reapplied to the wireline as it moves from the upper sheave 30 to the lower sheave 50 allowing the grease to be conveniently transported to the ground surface for recapture.

FIG. 1 illustrates one exemplary embodiment of the wellhead 70 being serviced by the wireline 20, which is directed into a well bore utilizing an upper sheave 30 and lower sheave 50. As shown, the wireline 20 extends from a winch unit in a generally horizontal orientation near ground-level to the lower sheave 50. The lower sheave 50 includes a pulley/grooved wheel for holding the wireline 20. The grooved wheel rotates inside a frame of the lower sheave 50, which allows the wireline 20 to move freely. More specifically, and lower sheave 50 redirects the wireline 20 from a first orientation substantially parallel to the operating surface (not shown) to a second orientation that is substantially vertical. The wireline 20 extends from the lower sheave 50 upwards to the upper sheave 30, which also includes a grooved pulley. The wireline 20 passes around the upper sheave 30 and is redirected downwards into the wellhead 70 to lower tools into the wellbore or retract tools from the wellbore. In the illustrated embodiment, the wellhead 70 or ‘Christmas tree’ is a set of valves, spools and fittings connected to the top of a well to direct and control the flow of formation fluids from the well.

To maintain pressure within the wellhead during insertion and retraction of tools, a lubricator assembly (hereafter lubricator) 72, consisting of additional valves, BOP's, and wireline deployment devices, is affixed to the top end of the wellhead 70. The lubricator is a high-pressure intervention system fitted to the top of the wellhead 70 that allows tools to be placed and run into the high-pressure wellbore. The top of the lubricator assembly includes a high-pressure grease-injection system (hereafter grease head) 74 and sealing elements. In use, the lubricator 72 is installed on top of the wellhead 70 and tested, the tools placed in the lubricator and the lubricator pressurized to wellbore pressure. Then the top valves of the tree are opened to enable the tools to fall or be pumped into the wellbore under pressure. To remove the tools, the reverse process is used: the tools are pulled up into the lubricator under wellbore pressure, the tree valves are closed, the lubricator pressure is bled off, and then the lubricator may be opened to remove the tools.

The grease head 74 is an assembly of components used to contain wellhead fluids and pressure during wireline operations. The wireline 20 passes through a close-tolerance tube assembly as it enters or leaves the grease head. High-pressure grease is pumped into the surrounding annulus to effect a pressure-tight dynamic seal that is maintained during the operation by injecting more grease as required. A slight leakage of grease is common and the addition of fresh grease enables the consistency of the seal to be maintained at an effective level. Collectively the wellhead 70, lubricator 72 and grease head 74 allow for the insertion of tools into the wellbore while maintaining pressure within the well. In addition, the grease head 74 may include a grease stripper or wiper 76 that removes some of the grease from the wireline 20 as it exits the grease head 74. However, some grease and/or well fluid (hereafter grease) remains on or within the wireline as it is retracted upwards toward the upper sheave.

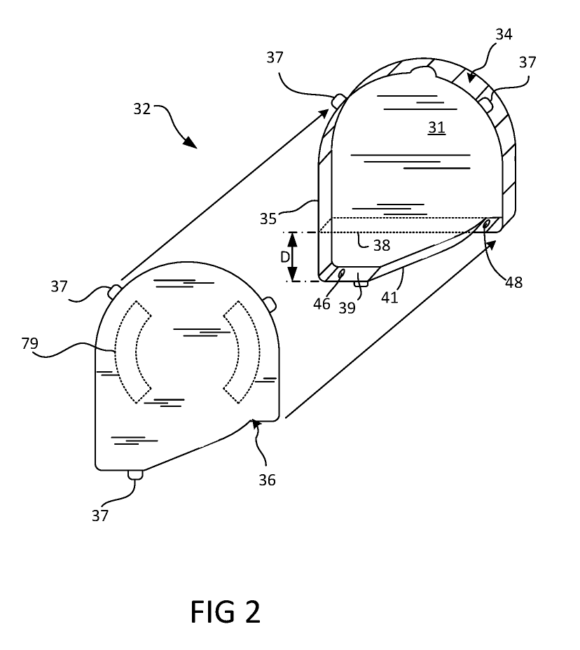

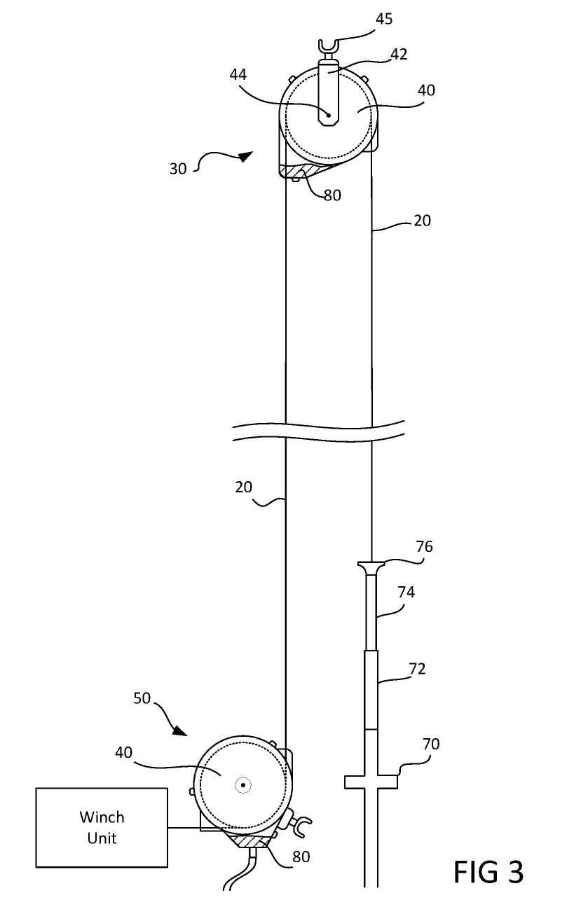

FIGS. 2 and 3 illustrate one embodiment of the sheave housing 32 of the upper sheave 30. More specifically, FIG. 2 illustrates the sheave housing 32 removed from the upper sheave 30 and FIG. 3 illustrates the system of FIG. 1 with sheave housing covers removed to show the internal components of the sheaves 30, 50. As shown, the sheave housing 32 is configured to fit over and around a sheave having a pulley 40 rotatably coupled to a sheave frame 42 via an axle 44. In the illustrated embodiment, the sheave frame 42 is attached to a sheave hanger or shackle 45, which is utilized to suspend the upper sheave 30. Typically, the sheave housing 32 will attach in some combination to the shackle 45, axel 44, and/or frame 42. Though shown as having a semi-circular/rounded upper surface that substantially matches the shape of the pulley, it will be appreciated that the sheave housing 32 is not limited to any particular shape. Further, the housing may include additional/optional features such as site windows 79 (e.g., for the purpose of visually verifying that the sheave wheels are in fact turning).

Generally, the sheave housing 32 defines a shroud that fits over and around the sheave pulley 40 and sheave frame 42 without obstructing the operation of these components. That is, while the sheave housing 32 is adapted to fit over and around the pulley and typically the frame, the pulley continues to freely rotate without obstruction by the housing. The housing is configured to: allow the wireline 20 to enter the housing 32; engage the pulley 40 at a first position; rotate around a periphery of the pulley 40 to a second position where it disengages the pulley; and exit the sheave housing 32, all free of obstruction. To permit a wireline to enter and exit the sheave housing 32 free of obstruction, lower portions of the sheave housing 32 have first and second wireline inlet/outlet apertures 46, 48, which may be commonly or differently configured as more fully discussed herein.

Referring again to FIG. 2, the housing 32 in the present embodiment is a two-piece housing. The housing includes a recessed housing portion 34 with an at least partially closed back surface 31 and a substantially continuous sidewall 35. The present embodiment of the housing also includes a generally planar cover 36 that mates with a sidewall 35 of the recessed housing portion 34. When connected, recessed housing portion and cover substantially enclose the wireline sheave. Though illustrated as having a recessed housing and generally planar cover, it will be appreciated that the housing may be defined by two recessed members that mate, for example, as equal halves. In any embodiment, various clasps 37 may be utilized to attach these components to one another and/or to the sheave. Any appropriate connection mechanism between these components may be utilized. The interior of the illustrated recessed housing portion 34 has a depth that, alone or in combination with the cover 36, allows for receiving and at least partially surrounding the sheave pulley 40. More specifically, a radial edge of the pulley 40 is disposed within an interior of the housing about its periphery between where the wireline engages and disengages the pulley. Stated otherwise, the pulley is surrounded by a substantially continuous sidewall 35 of the housing 32. Accordingly, any grease that is freed from (e.g., sprays off) the wireline as it rotates about the pulley is contained by the sidewall 35 of the housing 32. Once the sheave pulley is disposed within the sidewall 35 of the recessed housing 34 and the cover 36 is attached, the pulley and typically the frame are substantially encased within the housing 32. As will be appreciated, a seal element (not shown) may be disposed between engaging surfaces of the recessed housing portion 34 and the cover 36. Accordingly, when the cover 36 is attached to the recessed housing portion, the interior of the housing 32 may be substantially sealed with the exception of the wireline inlet/outlet apertures. In this regard, any grease that is freed from the wireline 20 is contained within the housing 32.

The grease freed from the wireline 30 and contained within the housing 32 migrates downwards towards bottom of the housing 32 under the influence of gravity where it accumulates. To allow transfer of the accumulated grease from the upper sheave 30 to the lower sheave 50 utilizing the wireline 20, the upper sheave housing 32 has a grease trap or well 38 located in its lower or lowermost portion (i.e., when the sheave housing is suspended). The grease trap 38 forms an enclosed area with open top surface that allows the trap to receive grease from the remainder of the housing interior. In the illustrated embodiment, the well or grease trap 38 is formed or a bottom floor portion 39, an angled/sloping sidewall portion 41, a lower portion of the sidewall, the back surface 31 of the housing and the cover 36. To allow transporting grease to the lower sheave, the grease trap 38 is disposed proximate to the inlet/outlet 46 for the portion of the wireline 20 extending between the upper sheave 30 and the lower sheave 50. In the illustrated embodiment, the inlet/outlet 46 extends through a floor portion 39 of the sidewall 35. That is, the grease trap 38 typically forms the lowest surface of the housing 32 (i.e., when suspended) and the wireline extends through the floor portion 39. Grease accumulates on the floor portion 39 of the well 38 about the inlet/outlet aperture 46 for the portion of the wireline 20 that extends between the upper sheave 30 and lower sheave 50. In contrast, the second inlet/outlet 48, for the portion of the wireline 20 extending between the upper sheave 30 and the wellhead 70, is positioned within the sheave housing 32 at a distance ‘D’ vertically above the floor 39 of the grease trap 38 (i.e., when suspended). That is, the second inlet/outlet 48 exits the housing in a vertical position above the first inlet/outlet 46 when the upper sheave 30 is suspended.

As best illustrated in FIG. 3, the shape of the housing 32 including the lower grease trap or well 38 permits grease 80 to accumulate within the housing 32 about the first inlet/outlet 46. During retraction of the wireline 20, where the wireline passes from the upper sheave 30 toward the lower sheave 50, the wireline passes through the accumulated grease 80. The passage of the wireline through the accumulated grease 80 within the grease trap 38 allows for the grease to become re-entrained onto and/or into the wireline such that it is drawn through the inlet/outlet aperture 46 and travels downward toward the lower sheave 50.

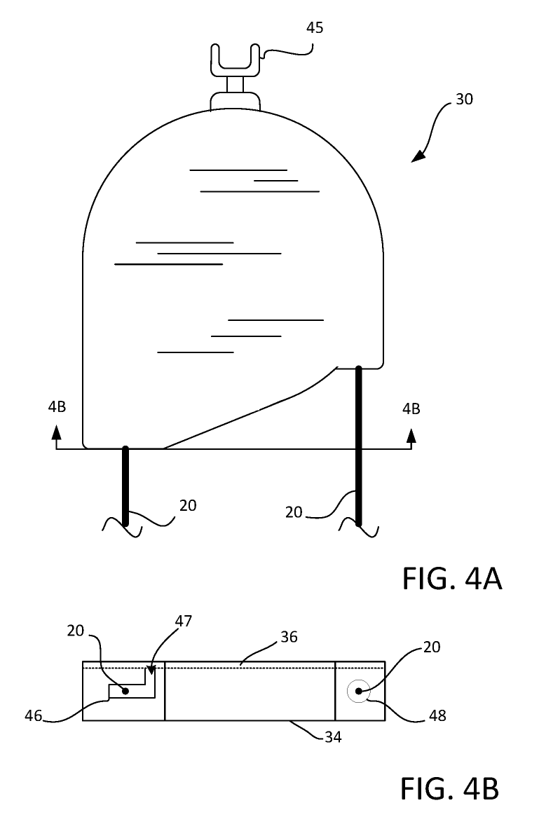

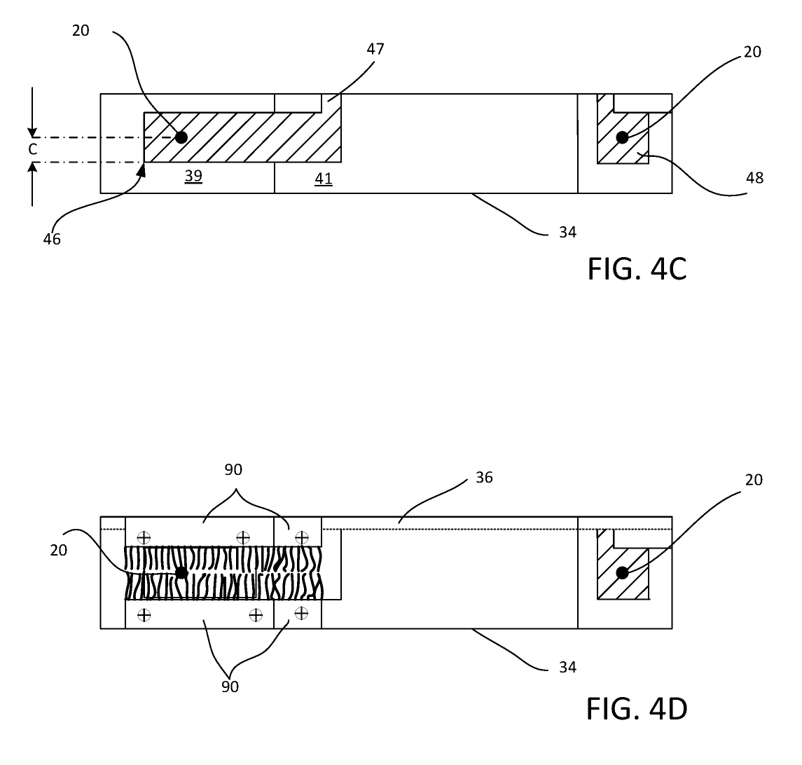

FIGS. 4A and 4B and illustrate a side view of the upper sheave housing 32 and a first embodiment of a bottom view of the sheave housing, respectively. As shown in this exemplary embodiment, the second inlet/outlet aperture or ‘wellhead side’ aperture 48 is illustrated as being a round aperture having a size that is considerably larger than the wireline 20 disposed therein. In this regard, the wellhead side aperture 48 permits passage of the wireline 20 into and out of the housing 32 free of obstruction and with minimal or no contact/rubbing. In this illustrated embodiment, the first inlet/outlet or ‘grease trap’ aperture 46 is illustrated as a narrow slot that permits passage of the wireline into and out of the housing 32. As shown, the grease trap aperture 46 has a cable insert slot 47 that extends from the aperture/slot 46 to the edge of the recessed housing 34. This insert slot 47 permits convenient application of the housing to a sheave while the wireline is already inserted around a pulley of the sheave. Though not illustrated, the wellhead side aperture 48 may also include a cable insert slot that extends to an edge of the housing.

In one embodiment, the grease trap aperture 46 has a tight tolerance to the wireline diameter to permit application of accumulated grease back onto the wireline as it is retracted while maintaining the accumulated grease within the housing. However, to minimize rubbing of the wireline on the edges of the apertures, it is typically desirable that apertures/slots have a clearance ‘C’ (See, e.g., FIG. 4C) that is approximately two times to approximately four times the diameter of the wireline. For instance, common wireline diameters include ¼ in., 9/32 in., and 5/16 in. Accordingly, to reduce rubbing on the edges of the apertures and reduce abrasion of the wireline cable, it is desirable that the clearance around such cables be between, for example, about ½ in. and about 1 in. When providing significant wireline clearance, the grease trap aperture may utilize a grease containment element. That is, in order to maintain grease within the housing grease trap or well 38, the grease trap aperture 46 may include retaining element(s) that permits the wireline to easily pass through while maintaining most or all of the grease within the housing. For instance, the first inlet/outlet aperture 46 may include a detent or inverted conical configuration to enhance fluid transfer to the cable with a low density retaining element such as rubber wiper, which is replaceable, or interchangeable, Similar the second inlet/outlet aperture 48 may also include similar elements such as a detent in vertical orientation to limit escape of fluids and provide additional damming of fluids from spilling out.

FIGS. 4C and 4D illustrate one embodiment of retaining elements 90 applied to the grease trap aperture 46 that allows: maintaining accumulated grease within the housing; passage of the wireline 20 substantially free of abrasion; and spreading grease onto the wireline 20 while it is retracted. In the illustrated embodiment, the retaining elements 90 are formed of brushes attached to the housing about the aperture 46 using various fasteners. The brushes 90 each include a plurality of bristles that extend over a portion of the aperture 46. The bristles readily allow deflection to permit the wireline to pass through while providing enough structure to maintain a majority of the accumulated grease within the housing. Further, the bristles allow for spreading or applying grease onto the wireline as it is retracted.

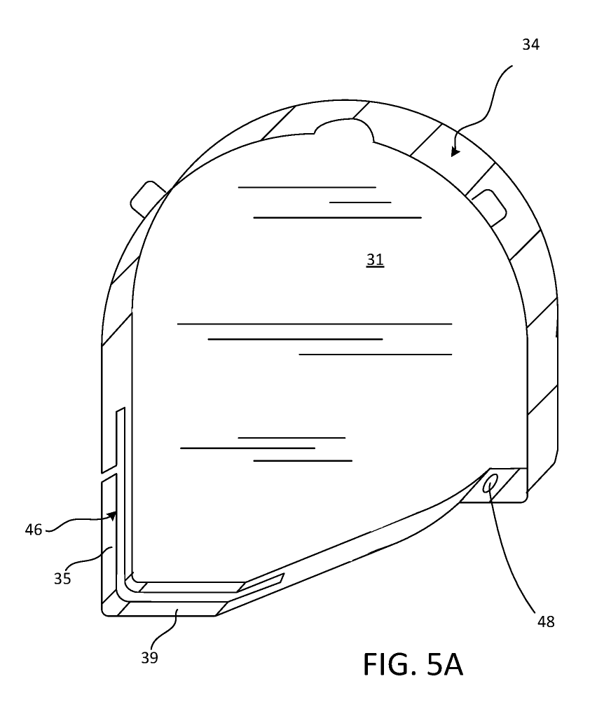

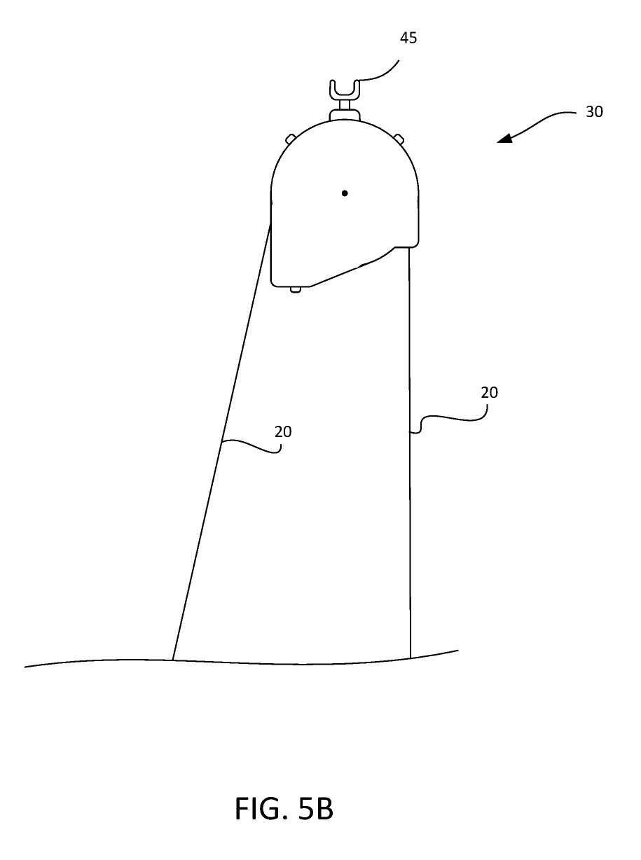

It will be appreciated that other configurations are possible for the apertures and that and that both inlet/outlet apertures may be similarly configured or differently configured. Generally, the inlet/outlet apertures may be optimized in shape and form to enable cable passage, in conjunction with grease containment, and reapplication of grease to the cable. As further illustrated in FIGS. 4C and 4D, the cable insertion slot 47 may be formed in a surface other than the floor 39. That is, the cable insertion slot may pass through the sidewall or in the illustrated embodiment, the angled bottom wall 41 such that the cable inlet 47 is not formed in the bottom of the grease trap. However, this is not a requirement. By way of example, FIG. 5A illustrates an alternate embodiment of a an upper sheave housing 34 having a grease trap aperture 46 that extends through both the bottom floor portion 39 and sidewall 35 of the housing. The extension of the aperture 46 through the sidewall may permit the upper sheave 30 to be utilized with a lower sheave that is not directly below the upper sheave 30. See FIG. 5B. That is, the aperture/slot 46 extending through a side surface of the housing (e.g., when suspended) permits a wireline 20 to enter the housing at an angle. Accordingly, a lower sheave may be offset from the upper sheave.

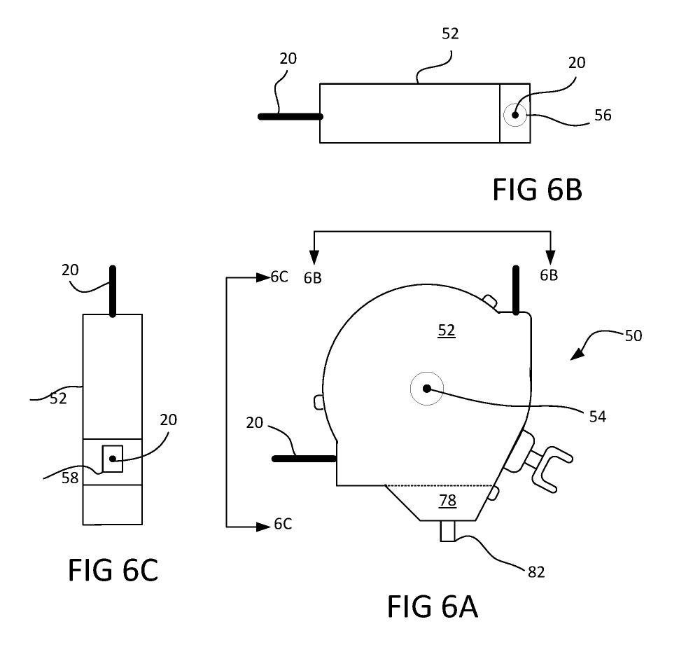

FIGS. 6A, 6B and 6C illustrate side, top and edge views, respectively, of the lower sheave 50 which also includes a containment housing 52 to contain grease freed from the wireline 20 during use. The sheave housing 52 is again configured to fit over and around a sheave having a pulley rotatably coupled to a frame via an axle 54. The sheave frame is supported on the operating surface or by the well head (neither shown). The lower sheave housing 52 again defines a shroud (e.g., housing and cover) that fits over and around at least the radial edge of the sheave pulley without obstructing the operation of the pulley. The housing 52 includes a first and second wireline inlet/outlet apertures 56, 58 to permit the wireline 20 to enter and exit the housing 52 free of obstruction. However, unlike the upper sheave housing, the planes of these apertures are typically perpendicular to one another.

To allow for capturing grease that is delivered to the lower sheave 50 from the upper sheave 30, or from the winch unit, the lower sheave housing 52 also includes a grease trap or well 78 that forms the lowest portion of the housing 52. As shown, the well 78 includes a spout 82 that may be attached to a hose or disposed over a catchment device such as a bucket. Though the configuration of the wireline inlet/outlet apertures of the lower sheave housing are differently oriented, the lower sheave housing is similarly constructed to the upper sheave housing.

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. A containment housing configured to at least partially surround a pulley of a suspended wireline sheave without hindering movement of the pulley, comprising:
a sidewall configured to surround at least portion of a radial edge of the pulley between a first position where a wireline engages the pulley and a second position where the wireline disengages the pulley;
a grease well disposed below the pulley when the pulley is suspended, wherein grease freed from the wireline while passing around the radial edge of the pulley accumulates within said grease well;
a first wireline aperture extending through a floor surface of said grease well and providing wireline access to the first position on the pulley; and
a retaining element disposed about said first wireline aperture, wherein said retaining element permits passage of the wireline through said first wireline aperture while at least partially impeding passage of grease through said first wireline aperture.

2. The housing of claim 1, further comprising:
a recessed housing portion, wherein said sidewall forms a sidewall of said recessed housing portion; and
a cover adapted to engage said recessed housing portion, wherein said recessed housing portion and said cover collectively define said grease well.

3. The housing of claim 2, wherein said sidewall is substantially continuous about a periphery of said recessed housing portion, wherein said floor surface of said grease well is a portion of said substantially continuous sidewall.

4. The housing of claim 3, further comprising:
a second wireline aperture extending through said sidewall providing wireline access to the second position on the pulley, wherein said second wireline aperture passes through said sidewall at a vertical position above first wireline aperture when the pulley is suspended.

5. The housing of claim 1, wherein said first wireline aperture comprises an open cross-dimension at least twice the diameter of the wireline.

6. The housing of claim 5, wherein said first wireline aperture comprises an elongated slot.

7. The housing of claim 1, wherein said retaining element comprises:
a plurality of bristles that extend across at least a portion of said first wireline aperture.

8. The housing of claim 1, wherein said retaining element comprises:
a first plurality of bristles extending over a first portion of said first wireline aperture; and
a second plurality of bristles extending over a second portion of said first wireline aperture.

9. A containment device configured to at least partially surround a pulley of a wireline sheave disposed proximate to an operating surface, comprising:
a recessed housing configured to substantially surround a pulley of a wireline sheave without hindering movement of the pulley, the recessed housing having:
a sidewall surface that extends around at least a portion of the pulley;
a first wireline aperture extending through an upper surface of said housing providing access for a vertical portion of a wireline to engage a first position of the pulley;
a second wireline aperture extending through a side surface of said housing providing access for a horizontal portion of the wireline to engage a second position on the pulley, wherein the wireline extends about the pulley between the first and second positions;
a cover adapted to mate with said recessed housing to substantially enclose the lower sheave within the recessed housing; and
an outlet in the recessed housing at a vertical location below the first and second wireline apertures, wherein grease freed from the wireline while inside the sheave housing drains through said outlet.

10. The device of claim 9, wherein said recessed housing and said cover collectively define:
a well at a vertical location below the first and second wireline apertures, wherein grease freed from the wireline while inside the sheave housing accumulates within the well, wherein said outlet extends through a lower surface of said well.

11. A system for use in conducting downhole well operations, comprising:
an upper sheave suspended above a well bore and having an upper pulley;
an upper housing, at least partially encasing the upper sheave, the upper housing having a sidewall surrounding at least a portion of a radial edge of the upper pulley, a grease well disposed below the upper pulley, and a first wireline aperture in said grease well;
a lower sheave positioned proximate to an operating surface and having a lower pulley;
a lower housing at least partially encasing the lower sheave, the lower housing having a sidewall surrounding at least a portion of a radial edge of the lower pulley;
a wireline extending vertically from said lower pulley upward through said first wireline aperture in said grease well to said upper pulley, wherein said wireline draws grease from said grease well through said first wireline aperture and transports said grease to said lower housing when said wireline is retracted from said upper housing to said lower housing.

12. The system of claim 11, wherein said upper housing further comprises:
a recessed housing portion, wherein said sidewall forms a sidewall of said recessed housing portion; and
a cover adapted to engage said recessed housing portion, wherein said recessed housing portion and said cover collectively define said grease well.

13. The system of claim 11, further comprising
a second wireline aperture extending through said upper housing at a vertical position above said first wireline aperture.

14. The system of claim 11, further comprising a retaining element disposed about said first wireline aperture, wherein said retaining element permits passage of the wireline through said first wireline aperture while at least partially impeding passage of grease through said first wireline aperture.

15. The system of claim 11, wherein said lower housing further comprises:
a grease well formed within said lower housing at a vertical position below third and fourth wireline apertures where the wireline enters and exits the lower housing, wherein said grease transported from said upper housing accumulates in said grease well of said lower housing.

16. The system of claim 15, further comprising:
a drain outlet extending through said lower housing into said grease well.

17. A method for use with a wireline, comprising:
substantially surrounding an upper pulley of an upper wireline sheave within a housing to capture grease that spraying off of a wireline while being retracted from a well bore into the housing and around the upper pulley;
accumulating captured grease in a lower portion of the housing about a wireline aperture, wherein the wireline extends through the wireline aperture between the upper wireline shave and a lower wireline sheave;
coating the wireline exiting the housing through wireline aperture with the captured grease to transport the grease to the lower wireline sheave; and
collecting grease from the wireline proximate to an operating surface and a lower sheave.

18. The method of claim 17 further comprising:
substantially surrounding a lower pulley of the lower wireline sheave within a lower housing to capture grease that spraying off of the wireline while being retracted from the upper wireline sheave into the lower wireline sheave and around the lower pulley.

19. The method of claim 18, further comprising:
accumulating said grease within said lower housing.
